(19) United States
(12) Patent Application Publication
(10) Pub. No.: US 2007/0129959 A1
(43) Pub. Date: Jun. 7, 2007

(54) VIRTUAL BUSINESS CARD AND METHOD FOR SHARING CONTACT INFORMATION ELECTRONICALLY

(75) Inventors: Joseph R. Bransky, Huron, OH (US); John Perlick, Libertyville, IL (US)

Correspondence Address: Thomas Moga;Butzel Long, STONERIDGE WEST, 41000 WOODWARD AVENUE, BLOOMFIELD HILLS, MI, 48304, US

(73) Assignee: Joseph R. Bransky, Huron, OH (US)

(21) Appl. No.: 11/608,082

(22) Filed: Dec. 7, 2006

Related U.S. Application Data
(60) Provisional application No. 60/748,318, filed on Dec. 7, 2005.

(51) Int. Cl. G06Q 99/00

(52) U.S. Cl. 705/1

(57) ABSTRACT

An apparatus and system for sharing contact information for a contact information database electronically, the system comprising a first and second electronic device, each of device having memory module for storing data, the devices having contact information stored as computer readable data and an integrated wireless radio module, for wirelessly communicating with other devices. The devices establish a wireless connection via the wireless radio modules, send the contact information to via the wireless connection, store the contact information on the memory modules and transfer the contact information to the contact information database.

### CROSS-REFERENCE TO RELATED APPLICATION

This application claims the benefit of U.S. provisional patent application Ser. No. 60/748,318 filed Dec. 7, 2005.

### BACKGROUND OF THE INVENTION

1. Field of the Invention

The present invention relates generally to an apparatus and a method for sharing business contact information electronically and, in particular, to an apparatus and a method allowing two or more people to wirelessly exchange business contact information.

2. Description of the Art

For centuries, businessmen and socialites have exchanged paper calling cards and business cards. These cards typically show a person's name, company, title, address or other contact information. Complex traditions, rituals and etiquette have grown around the simple exchange of business cards.

The ceremony and importance of the human element in the business card exchange remains important, but today, business contact information needs to be maintained electronically, and other opportunities for business card information exchange are described. There are programs such as Microsoft Outlook® and Best Software Act! from. These electronic contact management software programs facilitate communication, organization and storage of business contacts.

Unfortunately, there is not a straightforward way to electronically transfer business contact information directly into these contact managers at a first meeting. The best solution is to exchange paper business cards and later either manually enter or scan the contact information into an electronic contact manager.

Even portable electronic devices, such as the Personal Digital Assistants (PDAs), such as those made by Palm® and Sony®, are unable to easily transfer business contact information.

Contact information can be easily embedded or attached to an e-mail message. Some software programs can capture this contact information. However, this methodology relies on an Internet connection—which is rarely available or cumbersome in business meeting environments.

The problem is that no standardized medium has been developed to facilitate the electronic exchange of business contact information. The present invention is a system that creates an environment or setting for the efficient and effective mutual electronic exchange of business contact and other related information. The medium of the present invention is a radio (wireless) link or a wired connection along with software protocols that transfer the contact information electronically and store it in a useful format in the recipient's electronic machine. Two types of wireless communications available today or in a few months are Bluetooth® and Wibree.

Bluetooth is a popular short range, low power radio frequency (or “wireless”) communications technology developed by an international consortium of electronics corporations. The original developers, Ericsson, IBM, Intel, Nokia, and Toshiba, formed the Bluetooth Special Interest Group (SIG) in February 1998. Today, over 1300 “Associate” and “Adopter” member companies have joined the Bluetooth SIG and market-focused Bluetooth SIGs.

Bluetooth devices operate in the unlicensed 2.4 GHz internationally-assigned Industrial, Scientific and Medical (ISM) band. Complex radio technologies are used to combat interference and signal fading while providing a fast 1.0 Mbps data rate. Faster data rates of 2-3 Mbps are possible with Enhanced Data Rate modes. Bluetooth devices can communicate up to about 30 feet in distance.

Typically, several Bluetooth devices will simultaneously occupy the same RF channel. They can automatically operate as a small network called a “piconet.” Once device, called the “master” will provide a common clock and synchronization sequence for the remaining “slaves.” The piconet is the basis of Bluetooth wireless technology.

In addition to sophisticated microwave radio techniques, Bluetooth devices incorporate advanced software architectures. There are four layers of hardware and software above the microwave link layer. These layers implement the communications management and control protocols that process the transfer of data across the piconet.

Bluetooth-enabled devices include cell phones, headsets, PDAs, laptop and desktop computers, printers, keyboards, mice, games and toys, cameras, home automation, and industrial products.

Wibree is a new, open communications protocol standard developed by Nokia. It is targeted at devices with short, intermittent data exchanges. Wibree devices also operate in the unlicensed 2.4 GHz international ISM band. It provides a data rate of 1 Mbps and can communicate at a distance of up to 5-10 meters. Wibree uses a fraction of the power that other radio technologies use and therefore is a complementary technology to Bluetooth where low power, small size a low cost are requirements. Wibree may be standalone or an add-on inside existing Bluetooth circuitry.

As is described herein below, the present invention contemplates the use of a wireless radio communications protocol such as Bluetooth and/or Wibree.

The following United States patents are of interest to the technology of the present invention:

U.S. Pat. No. 5,278,673—This patent describes a hand-held device that scans, records, displays and exchanges business card information. This patent appears to focus on the scanning and display operations, but does describe a simple wired electronic interface to exchange files between like devices or a computer.

U.S. Pat. No. 5,493,105—This patent describes several embodiments of a device called an “electronic business card” that is similar to the modern-day personal digital assistant. It describes communications with other similar devices and stores contact information. It does not, however, clearly show how it communicates other than through an audio modem or a vaguely described “communications interface adapted to accept said computer readable data.” This patent does not contemplate the modern communications technologies described herein.

U.S. Pat. No. 5,555,105—This patent describes a small, portable business card image copier (or scanner). The device scans the paper business card and stores the information in bit map form. It does not contemplate optical character recognition. It does describe a data I/O port to connect the device to a computer or printer.

U.S. Pat. No. 5,604,640—This reference describes a stand-alone business card scanner that scans, records, displays and exchanges business card information stored either as printed text, bar code, or magnetic strip.

U.S. Pat. No. 6,012,102—This reference shows a special bar code printed on a business card to store a “data resource identifier.” The code is scanned into a computer and a computer program can establish a link to the specified data resource. The code can be a URL for access to an Internet web site. This concept utilizes a bar code system that automatically opens a web page based on the bar code data. The bar code includes a “resource specifier” or an abbreviated or encoded version of a web link.

U.S. Pat. No. 6,616,052—This patent shows a “digital business card” that uses two methods to electronically store business contact information on a traditional business card. First, the contact (or other) data is stored on an optical layer on the bottom of the card that is read by a conventional CDROM reader in a personal computer. The card also has a short magnetic strip that carries a short security password. The optical data can be read with any computer but the magnetic strip requires a magnetic strip reader—which provides, according to the inventor, greater security.

U.S. Pat. No. 6,650,761—This patent shows a business card with steganographically encoded data that is read by an optical sensor. Steganographic refers to the art and science of writing hidden messages in such a way that no one apart from the intended recipient knows of the existence of the message (such as a tiny image located in normal text). The data can be used to link to a remote data store.

U.S. Pat. No. 6,679,420—This reference shows a method of using a business card as an electronic mail token enabling a first user to record in a computer system an electronic mail address from a business card. The e-mail may be in “coded” form or may be a graphic symbol.

U.S. Pat. No. 6,783,060—This patent discloses a “Smart Business Card” with both printed and electronic storage of contact (or other) information. The contact information is stored on a magnetic strip on the back of the business card (like a credit card). The patent indicates that existing electronic business cards display up to approximately 100 characters due to the size of the magnetic strip. This patent discloses a software method to transfer stored name information automatically into a PDA such as a Palm® or computer.

U.S. Pat. No. 6,909,371—This reference discloses a method to track and electronically change the address and telephone number of a person. The nameplate contains an imbedded RFID tag containing the individual's social security number, employee number or name. When the nameplate is put into a special holder at the person's location (such as an office or apartment), the RFID tag is read and the person's location and phone number are automatically displayed and updated in a database.

U.S. Pat. No. 6,978,118—This patent shows the concept of a “data carrier” which is an RFID-bearing object. When the data carrier communicates to an RFID reader, the reader will establish communications with another device or network, using GSM, GRPS, WAP, EDGE or UMTS (all cell phone services) or Bluetooth.

### SUMMARY OF THE INVENTION

The present invention concerns an apparatus and method for sharing contact information for a contact information database electronically, the system comprising a first and second electronic device, each of device having memory module for storing data, the devices having contact information stored as computer readable data and an integrated wireless radio module, for wirelessly communicating with other devices. The devices establish a wireless connection via the wireless radio modules, send the contact information to via the wireless connection, store the contact information on the memory modules and transfer the contact information to the contact information database.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a perspective view of the apparatus in accordance with the present invention;

FIG. 2 is a perspective view of the apparatus in FIG. 1 with additional options;

FIG. 3 is a block diagram of the apparatus shown in FIG. 1;

FIG. 4 is a perspective view of an alternate embodiment of the apparatus shown in FIG. 1;

FIG. 5 is a block diagram showing the operation of the apparatus;

FIG. 6 is a view of an alternate embodiment in open state of the apparatus in FIG. 1;

FIG. 7 is a view of an alternate embodiment in closed state of the apparatus in FIG. 1;

FIG. 8 is a view of an alternate embodiment in open state of the apparatus in FIG. 6;

FIG. 9A is a view of a front of a business card;

FIG. 9B is a view of the back of a business card; and

FIG. 10 is a view of a bar encoded flash card.

### DESCRIPTION OF THE PREFERRED EMBODIMENT

U.S. provisional patent application Ser. No. 60/748,318 filed Dec. 7, 2005, is hereby incorporated herein by reference.

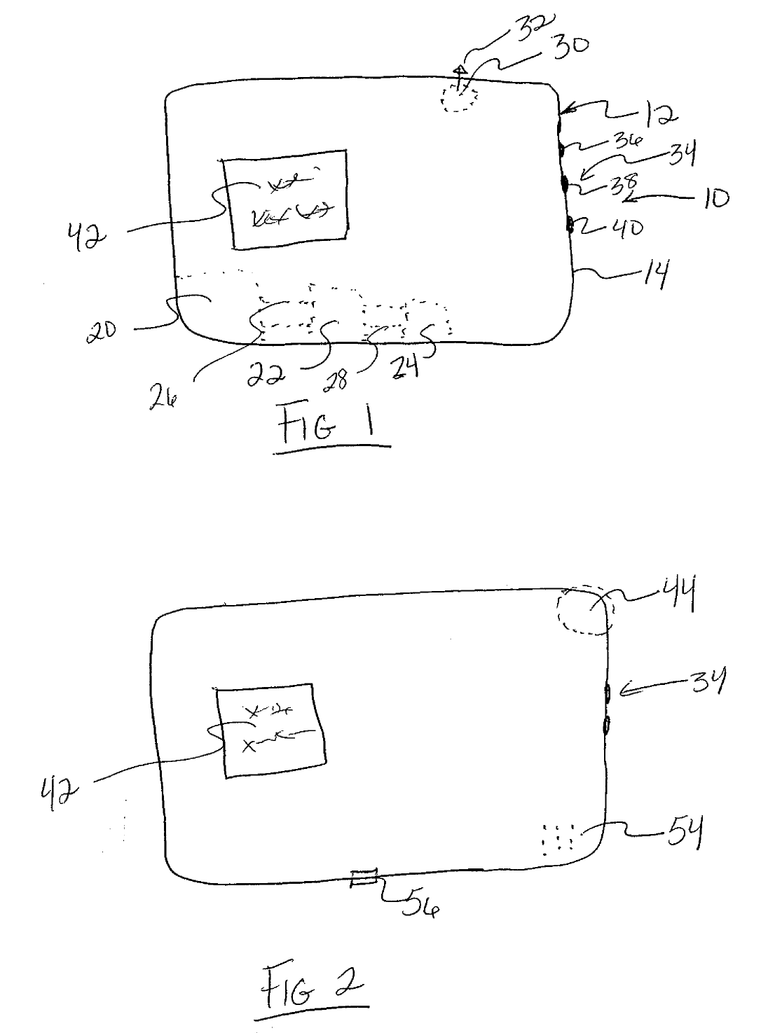

Referring to FIG. 1, the preferred embodiment of the Virtual Business Card (VBC) is a standalone VBC, shown generally at 10. In FIG. 1, the VBC 10 is shown as a small and relatively thin device about the size of a business card. One skilled in the art will appreciate that the standalone VBC 10 may take many different shapes without changing its operation or falling outside the scope of this disclosure. Additionally, the standalone VBC 10 could be integrated into a wallet or purse, an airline ticket or passport holder, a business card holder, or other similar non-electronic device (not shown).

The standalone VBC 10 consists of a housing 12 having walls 14 that determine the overall shape and size of the VBC 10. The walls 14 define an outside 16 of the VBC 10 and an opposite inside 18. The inside 18 of the VBC 10 is shaped and sized to encase certain elements of the VBC within the walls 14. Three elements encased by the housing are a microprocessor 20, a local memory device 22, and an input/output processor 24.

The microprocessor 20, memory device 22, and input/output processor 24 are connected by both an address bus 26 and a data bus 28 used for transferring information and instructions between each of the three elements 20, 22, 24. The microprocessor 20 controls the operation of the VBC 10 and is preferably a low power microprocessor such as the Intel® ARM-based microprocessor to conserve battery power. The local memory device 22 stores both the exchanged business contact information and the VBC operating software that controls the operation of the VBC. The business contact information stored in the memory 22 may contact information such as:

(a) Name;

(b) Company;

(c) Address;

(d) Phone/fax/mobile numbers;

(e) E-mail address;

(f) Organization;

(g) Organization logo;

(h) Title;

(i) Translated information (Spanish, Chinese, Japanese, etc.);

(j) Product/Marketing information;

(k) Photo; and

(l) Other special features such as web site address, etc.

The housing 12 also encases a wireless radio module 30 having an antenna 32 and connected to the microprocessor 20 for establishing wireless communication and transferring and receiving business contact information wirelessly. The radio module 30 may utilize any type of wireless radio technology, but preferably the Bluetooth standard, the newly developed WIBREE standard, or both are utilized in full compliance with their respective standards. Additionally, technologies such as RFID or ISM could be utilized, but Bluetooth and/or Wibree are preferred. One skilled in the art will appreciate that as additional wireless standards are developed in the future, those may also be utilized and are within the scope of this disclosure.

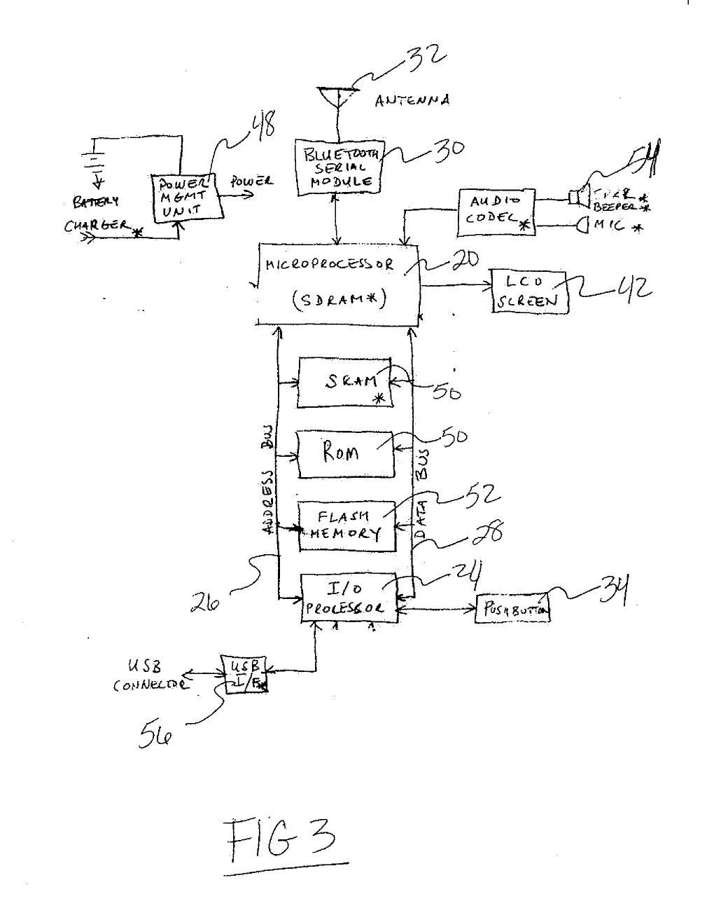

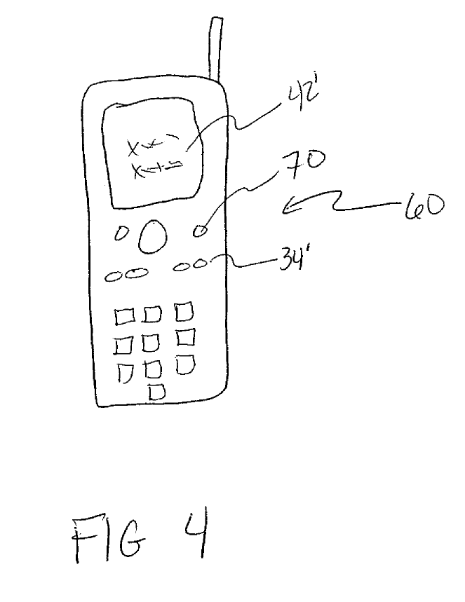

The VBC housing 12 further includes interface buttons 34, such as a scroll up/left button 38, a scroll down/right button 40, and a select button 36 for interfacing with the VBC 10. The buttons 34 are located on the outside of the housing 12 and connected to the input/output processor 24 through the wall 14 of the housing 12. In operation, and as will be explained more herein below, the VBC 10 starts in a “sleep” state. The select button 36 is pushed to “wake up” the VBC 10 from its low power shutdown condition and place the VBC 10 in a ready state, thereby enabling the VBC 10 to exchange contact information with other VBCs within its range provided that permission to exchange information is granted by the users of the other VBCs. The select button 36 is also used to put the VBC 10 into the sleep state and to select certain options when using the VBC 10. The scroll buttons 38, 40 are used to maneuver through different options on the VBC 10. The operation and use of these buttons will become more apparent from the illustrative example of a data exchange that is outlined herein below. Furthermore, additional or fewer buttons could easily be utilized or could be replace or used in combination with a scroll wheel 44 as shown in FIG. 2. The number and types of buttons 34, scroll wheels 44, etc are purely a design modification within the scope of this disclosure and requires a simple modification to the VBC operating software.

The VBC 10 further includes a display screen 42 such as an LCD screen located on the outside of the VBC 10 and connected to the microprocessor 20 for displaying device information to the user. The display screen 42 cues the operator with instructions during the contact information exchange process, confirms and displays results of the exchange, and allows the user to later review contact information stored on the VBC 10. Optionally, a touchscreen LCD screen may be utilized, thereby allowing the user to interact with the VBC by touching the screen and thereby removing the need for multiple interface buttons. Preferably, a touchscreen LCD screen and a scroll wheel 44 would be used in combination.

The elements of the VBC 10 such as the microprocessor 20 are powered by a small battery 46 encased by the housing 12. A small battery 46 is adequate because the VBC 10 is only intermittently powered on. A tiny current may be used when the VBC 10 is in the sleep state.

A power management circuit 48 would manage all power functions for the VBC 10, including monitoring and reporting battery capacity, and boosting and/or regulating battery voltages to the levels needed by the electronic circuitry.

FIG. 3 shows a block diagram of a stand-alone Bluetooth VBC 10 with optional equipment. A microprocessor 20, executing a program of stored instructions (or “software”), enables the VBC 10 functions. The microprocessor 20 controls the exchange of the VBC 10 data and stores it in the local memory device 22. The processor 20 may have on-chip cache memory, usually in SDRAM form. The microprocessor 20 system executes a traditional stored program and separate address 26 and data 28 busses. Each memory 22 or sub-processor, such as the input/output processor 24, on these two busses 26, 28 is multiplexed to these busses.

The VBC's microprocessor 20 operating software is fixed in low power CMOS ROM. The user's contact information along with any contact information received from others is stored in either RAM 50 or FLASH 52 memory in the VBC 10. The microprocessor 20 controls the data flow into and out of these memories 50, 52. For example, if the data exchange were requested, the microprocessor 20 would fetch the user's VBC 10 information and send it out the wireless radio module 30, and it would take in the received contact information from the wireless radio module 30 and store it in either the RAM 50 or FLASH 52 memory.

A more illustrative example of the VBC 10 in operation is helpful for an understanding of the present invention. Three business people, Allen, Julie, and Bill meet and agree to exchange contact information using their VBC 10 devices. First, each wakes up his VBC 10 from its low power sleep state, if needed, by pushing the select button 36. One of the three, let's say Allen, pushes the select button 36 which signals his VBC 10 that he wants to initiate an exchange of contact information. Allen's VBC 10 then searches for any other VBCs 10 within its wireless range that are operating on a compatible wireless protocol. In this case, Allen's VBC 10 would find Julie's and Bill's VBCs 10 and initiate a wireless communication with each one to obtain the device's public name, which is generally the name of the VBCs 10 user.

Once Allen's VBC 10 obtains the names of the other VBCs 10 in its range (in this case “Julie” and “Bill”), it displays the names of the available VBCs and asks Allen if he'd like to exchange his contact information with these other devices. At this point, Allen can use the VBC's 10 pushbuttons 34 (or scroll wheel 44, touchscreen, or some other input device) and the select button 36 to select all, none, or any number of the devices to exchange contact information with. Once Allen indicates that he wishes to exchange information with both Julie and Bill, his VBC 10 then communicates an exchange request with Julie's and Bill's VBCs 10. Once Julie's and Bill's VBCs 10 receive Allen's exchange request, each requires its user to accept the request by pressing the select button 36. Once Julie and/or Bill accepts, or gives permission, for the exchange, her/his VBC 10 wirelessly transfers contact information with Allen's VBC 10.

In this example, if both Julie and Bill accepted the request then Allen would have both Julie's and Bill's contact information and both Julie and Bill will have Allen's information. Julie and Bill could repeat the process in order to exchange information with each other. This exchange process is just one example of how information is transferred with the VBC 10. One skilled in the art will appreciate that software could be modified and that this exchange process could occur in many variations while remaining within the scope of the present invention. No matter how the exchange process is accomplished, the permission request to exchange information is key to securing the contact information. For example, Bill could select to exchange information with Julie and de-select Allen. This would prevent other VBCs that may be in range from exchanging contact information without permission.

Additional security features can be embodied in the VBC 10 software to control unauthorized exchange and unwanted VBC inquiries. These security features could include encryption of stored contact information and encrypted transfer of contact data (for example, using packet-key encryption approaches). The encryption would protect all stored data, including the user's contact information as well as all contact information received from earlier VBC transactions. A password would be required to decrypt the stored information. The password could also be the key in certain decryption algorithms.

In addition, the user can select to put the VBC 10 into the sleep mode where the wireless module is disabled—thereby preventing any exchanges with other VBCs 10. After completion of the exchange, the VBC 10 would ask the user if there were any further contacts to trade. If not, it would return to a low power sleep mode. Alternatively, the user can opt to put the VBC 10 in sleep mode at any time by performing some pre-determined action such as pressing and holding the select button 36.

Another key security feature of the VBC 10 software is that only the user's contact information can be exchanged. Allen could not, for example, later exchange Julie's contact information to a third party using the VBC 10 exchange process. This, however, would not prevent Allen from sharing Julie's contact information verbally or in another way with a third party. The reason for this security feature is to prevent Bill, for example, from obtaining all of the contact information stored in Allen's VBC 10, whether Allen has given permission for such exchange or not. Even with security embodiments in the device, users would be cautioned to only enter necessary contact information as part of the VBC 10 data.

Again, the software could be modified in many ways to change the details of operation of the exchange process without changing the overall scope of this disclosure. For example, upon initiating the exchange, all three devices could display the name of the other two so that as long as permission was given, all three could exchange their information at once instead of Julie and Bill having to repeat the process in order to obtain each other's information. Additionally, the number of buttons, the type of interface buttons 34, and/or the functionality of the buttons 34 could be modified without changing the scope of the present invention.

Referring to FIG. 2, the present invention also contemplates the addition of numerous options to the VBC 10, each of which could be added in many different combinations with each other. For example audio circuitry could be connected to the microprocessor for a sound emitting device such as a speaker 54 or beeper can be included. This can be used to acknowledge a interface button 34 press (with a click or beep), successful contact information exchange, acknowledge input device activity, warn of unintended operation or contact information exchanges, and confirm successful exchange of contact information. If a speaker 54 or even a headphone jack (not shown) is added in conjunction with the audio circuitry, the VBC 10 can also store music, messages, verbal reports, and other sound files. If a microphone (not shown) is added to the VBC, it can store verbal messages like voice recorders used by business people to save verbal notes. The addition of a microphone would also allow voice commands to replace or augment the input buttons or scroll wheel. With a speaker 54, the VBC could generate DTMF telephone tones to automatically dial the telephone number of a selected contact.

In some cases, the VBC 10 may be configured with additional plug-in memory (not shown) such as a MCM (multi-chip module) or SD (secure digital) memory module. The microprocessor 20 would also manage these memory structures and store received contact information on the card as requested by the user. The VBC 10 would also transfer contact data stored in the RAM 50 or FLASH 52 memory to the MCM or SD card at the request of the user. This would allow storage of more contact information and would allow the user to transfer stored contact data to another device (such as a personal computer or another VBC 10) using the memory card. Additionally, the VBC 10 may be configured with a PCMCIA interface (not shown). The PCMCIA card could contain additional memory to store additional contacts.

To protect the identity of the VBC 10 user in the event the VBC 10 is lost or misplaced, the VBC 10 may optionally be password- or security code-protected via the VBC 10 software. This protection would engage each time the VBC 10 is first turned on (that is, awakened from its low power sleep mode). The VBC 10 would request the password or security code (which might be as simple as a three or four digit code). The user would then enter this code using the interface buttons 34, the scroll wheel 44, or other input mechanism such as a touch screen. In the event that the correct code is not entered, the LCD display 42 would either not operate or would show a user-selectable message such as: “Return this VBC to such-and-such address, return postage guaranteed.”

A backlight (not shown) can be added to the LCD display 42 for easier viewing of the LCD display 42 in the dark or to signal device status.

Referring to FIG. 3, the VBC 10 may also include a USB 56 interface for allowing the user to connect the VBC 10 to a computer, a personal digital assistant (PDA), a printer, another USB enabled VBC 10, or another USB-enabled host or slave device. The USB interface 56 could be either a wired USB or a wireless USB interface (USB-W or WUSB).

The VBC 10 can communicate with a personal computer using USB 56 to perform two main functions: (1) setting up the VBC 10, that is, allowing the user to store his or her own contact information in the VBC 10 for sharing with others during VBC 10 exchanges, and other set-up procedures such as supplying passwords or personal data, setting the time and dates, etc. and (2) downloading contact information that has been acquired by exchange with other VBCs 10 to the computer. A computer program will facilitate these activities on the computer. This program will store the contact information that has been collected directly into the user's contact database program, such as Microsoft Outlook, Best ACT! or a Palm Desktop Software.

The USB interface 56 can also be used to directly print out the VBC 10 contact information. For example, the VBC 10 can incorporate a simple printer driver for a USB-enabled printer so that the user connects the VBC 10 to the printer's USB interface, then requests the printer to print a selected number or all of the stored contacts.

The USB interface 56 can also be used to interface to other USB-enabled contact information systems such as a PDA or cell phone. In this case, the contact information stored on the VBC 10 can be directly transferred to the PDA or phone where it can be stored in Outlook, ACT!, or other contact information databases.

Other useful functions can be added to the VBC 10 such as calendar functions, scheduling and event tracking, games and entertainment, a calculator and even email messaging (where a connection to a networked device is available). With suitable audio processing circuitry, it could even act as a telephone communicating to a host Internet or telephone appliance. The addition of these other functions leads us to the alternate embodiment of the present invention, which presents the VBC 10 being integrated into a multitude of pre-existing devices.

In a second alternate embodiment of the present invention, an integrated VBC 60 that can conceivably exchange contact information with any compatible wireless device that is also VBC-enabled is disclosed. This includes, but is not limited to, cellular telephones, PDAs, personal computers (desktop, laptop, handheld), electronic music players, electronic mapping devices, and automobiles. This allows for a wireless exchange between different types of devices so long as the devices operate compatible wireless protocols and are VBC-enabled. In this case, when the VBC 60 is turned on (awakened from its sleep state), it automatically scans for other devices within its range that utilize a compatible wireless communication protocol. If it finds such devices, the VBC 60 then inquires if those devices are VBC-enabled, meaning that the device has been loaded with VBC software allowing it to exchange contact information. When contact has been established between VBC-enabled devices, contact information may be exchanged in a similar format to that described earlier. Permission must be granted on both ends of the wireless link to allow a contact information exchange to occur.

The process of executing a contact information exchange with a wireless VBC-enabled device 60 such as a cell phone, PDA or computer would be the same as with the standalone VBC 10 and most importantly, these electronic devices can exchange contact information with another VBC of any type so long as they utilize compatible wireless protocols. For example, a cell phone VBC 60 can exchange contact information with a PDA or a standalone VBC 10 device. This is accomplished by a standardized VBC data format in a wireless protocol. Once the VBC exchanges wake-up data with another VBC device, all VBCs look alike as far as transferring information is concerned.

This standardized VBC data packet is key to recognizing VBC systems. When a VBC 60 is first turned on it emits a signal containing a VBC identifier. The identifier contains digital data that identifies that the sender is a VBC device and that it may be willing to exchange VBC data. The identifier also contains a public name of the VBC user (i.e. the user's first name, picture, or other identifying information).

This data packet is received by all other wireless VBC devices within radio range of the sender. They receive the data packet and either respond as a VBC or discard the information. When they respond, they send their own similar packet of data that identifies them as another VBC and also passes along the user's public name.

Each VBC (whether standalone or integrated) 10, 60 will display a message indicating that it has “detected” another (or multiple) VBCs within range. It will display the name of each remote VBC user detected and ask if the user wants to exchange contact information with these remote users. When a contact exchange is approved at both ends, the VBC will exchange contact information between the approved VBC devices.

The exchanged VBC contact information may include internet links (urls) to the user's website, home page, business or school website or another website or link as selected by the user. When a VBC exchange takes place, the link may be instantly accessed by the recipient to learn more about the person, their company, etc. if their VBC device 60 has internet access.

Similarly, the exchanged VBC contact information may include an email address as selected by the user. When a VBC exchange take place, the email address may be instantly accessed by the recipient to establish email communications if their VBC device has internet access.

A portable or mobile VBC 60 such as a standalone VBC or VBC-enabled cell phone or PDA can make a contact information exchange with a stationary VBC 10 such as a personal desktop computer. This would be beneficial in a business office lobby or trade show encounter. In such cases, the visitor would exchange contact information (or perhaps trade in only one direction) to log the visit or to request a follow-up such as a return phone call, a return email, or a literature request.

For further illustration of this system's capability of transferring contact information, using a multitude of devices and connections, refer to FIG. 5. FIG. 5 shows two devices 62 and 64 each operating the same wireless communication protocol (Bluetooth, Wibree, etc.). Each device 62, 64 is able to connect to a contact information database 66 and 68, respectively. The contact information databases 66, 68 could be contained within the device 62, 64 or within another device such as a personal computer. In a first example, device 62 could be a standalone VBC 10 as disclosed in the preferred embodiment and device 64 could be a cell phone with an integrated VBC 60. The standalone VBC 62 and the cell phone 64 could wirelessly communicate and transfer contact information, either in one direction or two, and then share that transferred information with their corresponding contact information database via a wired (USB, etc.) or wireless connection (Bluetooth, Wibree, USBW, etc.). For further illustration, the standalone VBC 62 could connect to a desktop computer (not shown) via a USB connection and transfer the contact information into Outlook while the cell phone 64 could wirelessly connect with a laptop computer (not shown) and transfer the information into an ACT! database.

As another example using FIG. 5, device 62 could be a PDA while device 64 is again a cell phone. The PDA 62 and the cell phone 64 exchange information wirelessly and then the PDA stores the information in a contact information database such as Outlook stored internally, while the cell phone wirelessly loads the information into a contact information database such as ACT!, stored on a desktop computer. Furthermore, the connection between the PDA 62 and the cell phone 64 could be a wired connection such as USB and the system will still work.

A third example using FIG. 5 could involve both devices 62, 64 being cell phones. During a cell phone call between 62 and 64 an electronic information exchange could occur and then be transferred to a contact information database accordingly. As one skilled in the art will appreciate, this system of transferring information has a multitude of scenarios, making it impossible to set forth all possible combinations in this disclosure.

Of course, any device being used in this process must have sufficient memory to store the contact information received from others and the software tool set to execute the VBC process. Some portable devices (such as advanced cell phones, portable computing devices, and PDAs) have contact information databases such as Outlook and ACT! A VBC software tool could automatically load received contact information into these databases.

These devices all have many functions unrelated to VBC 60 operations such as making phone calls, entertainment or data storage. To simplify VBC 60 operation, the device may have a single interface button 34 or “hot key” 70 that directly initiates the VBC function. When pressed, this VBC hot key 70 will start scanning for other available VBC 60 devices, and it will make itself available for VBC exchange. Once the VBC function has been opened or initiated, the user can quickly exchange contact information with another VBC device 60. The hot key 70 obviates the need to work through a series of menus or keystrokes to use the VBC functions.

The VBC may operate coincidentally with other resident functions on the integrated VBC 60. For example, the cell phone could continue to operate as a cell phone while a VBC exchange takes place. In an extension to this, during a phone call a person could send a data packet that contains the VBC exchange to the person he/she is connected to cellularly. Since cellular communication is already established, the local/short-range wireless connection (Bluetooth, Wibree, etc.) is not needed. The person would press the button to open the VBC function on the telephone handset, and would accept a VBC exchange with the “party being called.” This would allow an easy exchange of VBC data when the two callers are not within wireless range but still wish to exchange VBC information or when the VBC 60 users do not have compatible wireless protocols.

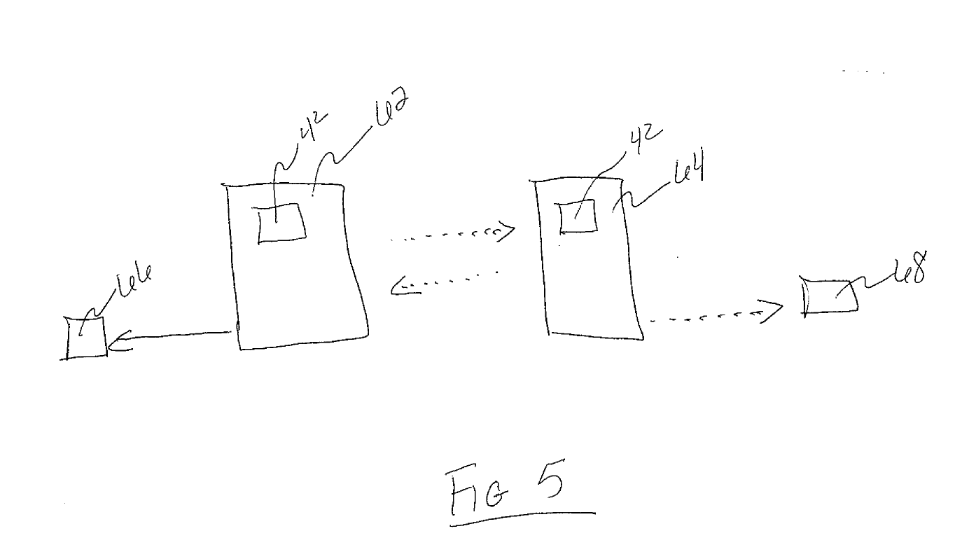

In a third alternate embodiment of the present invention wherein like parts are labeled as prime, a standalone VBC is embedded into a business card holder, as shown generally at 80 in FIG. 6. Businessmen often carry or store a small supply of business cards to share with associates at meetings. It is customary to carry or store these cards in a small protective carrier, or business card holder. This holder could be made of metal or plastic and typically is only as large as necessary to store a small (10-30) number of paper business cards. Referring to FIG. 6 the business card holder shown is fairly standard, having a bottom 82 having four edges 84 and a lid 86 also having four edges 88, wherein the bottom 82 and the lid 86 are substantially the same shape. The lid 86 is pivotally attached to one edge 84 of the bottom 82. The lid 86 has an inside face 90 facing the bottom 82 and an opposite outside face 92.

The bottom 82 of the holder 80 is adapted to hold a certain pre-determined number of paper business cards. As shown in FIG. 7, the holder 80 is in a closed state when all edges 88 of the lid 86 are adjacent to all respective edges 84 of the bottom. As shown in FIG. 6 the holder 80 is in an open state and allowing access to the stored business cards, when the lid 86 is pivoted away from the bottom 82 such that three of the edges 88 of the lid 86 are spaced apart from the respective edges 84 of the bottom 82.

In this embodiment of the present invention, the lid 86 serves as the housing 12 disclosed in the preferred embodiment. Similar to the housing 12 of the preferred embodiment, the lid 86 encases the elements of the VBC, including the microprocessor 20′ the local memory device 22′, the input/output processor 24′ the wireless radio module 30′, the interface buttons 34′, the scroll wheel 44′ the display 42′, the battery 46′, and any other elements discussed in conjunction with the preferred embodiment hereinabove. The LCD 42 and interface buttons 34 of the VBC may be located on the outside face 92 of the lid 86 of the holder 80. As shown in FIG. 7, the holder 80, when in its closed state, appears as if it is the standalone VBC 10 of the preferred embodiment.

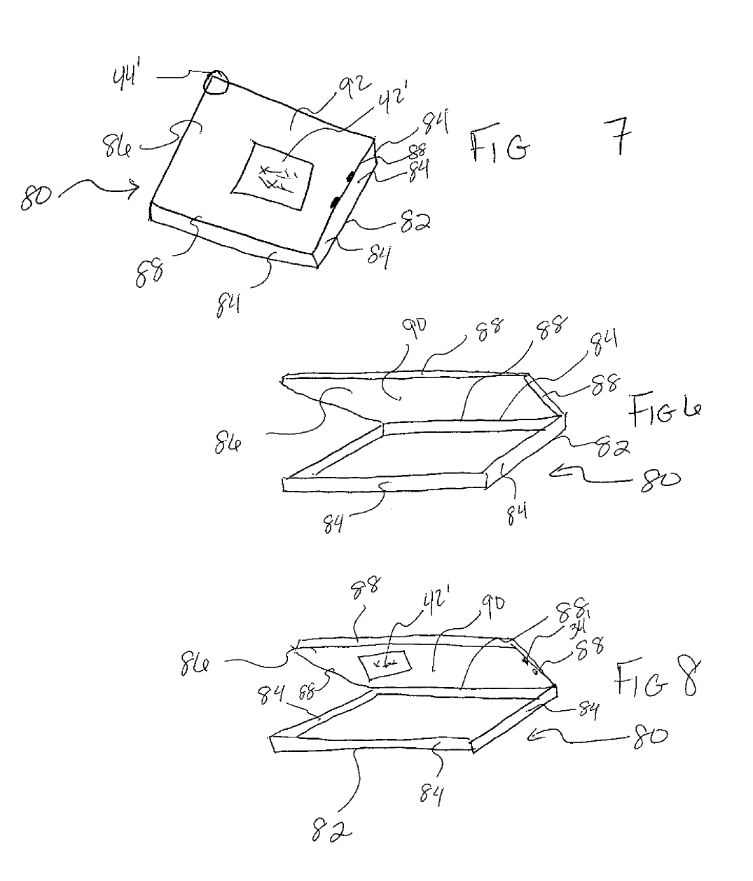

Alternatively, as shown in FIG. 8, the display 42′, the scroll wheel 44′ and the interface buttons 34′ for the VBC can be located on the inside face 90 of the lid 86. In such an arrangement, the VBC is accessed by putting the holder 80 in the open state by pivoting the lid 86 away from the bottom 82. When the holder 80 is in a closed state, the VBC is hidden from view and placed in its sleep mode. This can provide an added security feature since data exchanges are not possible if the VBC is in the sleep mode. The VBC can be placed in its active mode (awakened) either by opening the holder 80 or by opening the holder 80 and pressing an interface button 34′. In operation, the business card holder VBC 80 operates the same as the standalone VBC 10 as described hereinabove.

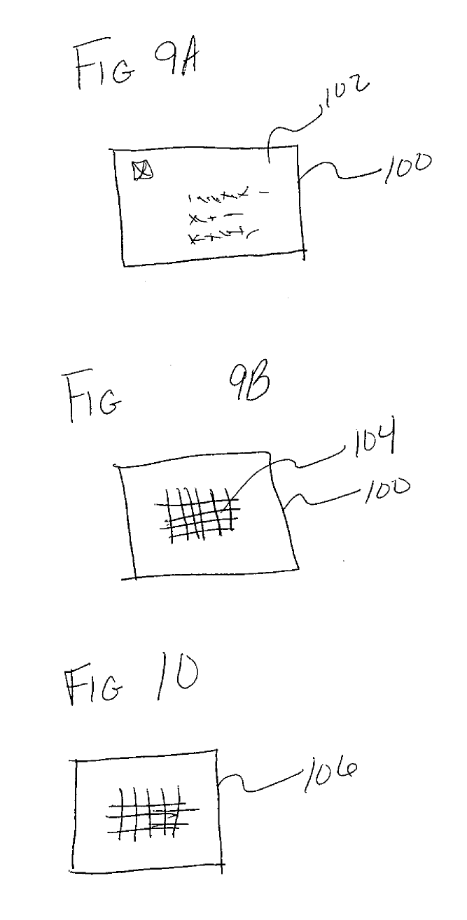

In a fourth alternate embodiment of the present invention, a bar code VBC and method for reading it is disclosed. Referring to FIGS. 9A and 9B there is shown a standard business card 100 having business contact information on one side 102 and a bar code 104 on an opposite, back side. This embodiment of the present invention contemplates the scanning of a printed 2 D bar code 104 containing an individual's business contact information. Examples of suitable 2D bar code formats include Dataglyphs (developed by Xerox Corporation), Data Matrix (standardized by ISO/IEC 16022—International Symbology Specification, Datamatrix), MaxiCode (developed by United Parcel Service, now in the public domain), and PDF417 (developed by Symbol Technologies, Inc.). Unlike the traditional bar code that only encodes 12 digits; the PDF417 bar code can contain 2710 characters, which is suitable for encoding a complete contact information file.

How the bar coding 104 gets on a card 100 is immaterial to the present invention. The focus of the present invention is the use of a portable device having a camera to read and/or scan the bar code 104 via the camera and then utilizing software to translate the bar coded information into a contact information database.

In operation, once a bar code 104 VBC is received, the recipient later scans the code 104 with a generic computer scanner, takes a picture of the bar code with a digital camera, or takes a picture of the bar code with a camera integrated into another device such as a cell phone. At this point, the recipient has an electronic file representing the bar code 104. Then, the recipient uses a bar code 104 translation software program that resides on a personal computer, a cell phone, a PDA, or another software-controlled electronic device to access the electronic file representing the bar code 104. The translation program then decodes the bar code 104 and creates a contact information file in a computer-readable format such as text, ASCII, hex, etc. Then, the file would be imported into the user's contact management program such as Outlook or ACT! At no point in the process does a central database need to be accessed via the Internet or such to obtain the contact information.

Alternatively, an individual could have his bar code 104 on a flash card VBC 106 that is only temporarily shared with a receiving party. The receiving party scans the flash card VBC 106 with a scanner or camera as above and then returns the flash card VBC 106 to the owner. Later, the receiver uses the electronic file just as explained above to obtain the contact information.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A virtual business card sharing system for sharing contact information for a contact information database electronically, said system comprising:
a first and second electronic device, each of said first and second device having a first and second memory module, respectively, for storing data;
said first device having contact information stored as computer readable data on said first memory module;
each of said first and second device having a first and second integrated wireless radio module, respectively, for wirelessly communicating with other said device; and
wherein said first and second devices establish a wireless connection via said first and second wireless radio modules, said first device sends said contact information to said second device via said wireless connection, said second device receives said contact information, stores said contact information on said second memory module and transfers said contact information to the contact information database.

2. A virtual business card sharing system as claimed in claim 1, wherein said second device has contact information stored as computer readable data on said second memory module and sends said contact information to said first device via said wireless connection, said first device receives said contact information, stores said contact information on said first memory module and transfers said contact information to the contact information database.

3. A virtual business card sharing system as claimed in claim 2, wherein said system includes at least two electronic devices, each said device having a memory module with stored contact information and an integrated wireless radio module for sending and receiving said contact information with other said devices.

4. A virtual business card sharing system as claimed in claim 2, wherein at least one of said first and second devices has a hard wire connection port for connecting to a multitude of compatible devices, including a computer, a personal digital assistant, and a printer.

5. A virtual business card sharing system as claimed in claim 1, wherein said wireless radio module operates one of the Bluetooth, the Wibree, or the WUSB wireless protocols.

6. A virtual business card sharing system as claimed in claim 1, wherein each of said devices includes a microprocessor for controlling the operation of said device.

7. A virtual business card sharing system as claimed in claim 6, wherein each of said devices includes a memory device for storing said contact information and a program for operating said device.

8. A virtual business card sharing system as claimed in claim 7, wherein each of said devices includes an input/output processor.

9. A virtual business card sharing system as claimed in claim 8, wherein each of said devices includes an address bus and a data bus used for transferring information and instructions between each of said microprocessor, said memory device, and said input/output processor.

10. A virtual business card sharing system as claimed in claim 9, wherein each of said devices includes a battery for powering said device.

11. A virtual business card sharing system as claimed in claim 10, wherein each of said devices further includes at least one interface control connected to said input/output processor for allowing a user to interface with said device.

12. A virtual business card sharing system as claimed in claim 11, wherein at least one of said devices further includes a display screen connected to said microprocessor for displaying device information to a user.

13. A virtual business card sharing system as claimed in claim 10, wherein each of said devices further includes a power management circuit connected to said battery and said microprocessor for managing all the power functions for said device.

14. A virtual business card sharing system as claimed in claim 11, wherein at least one of said devices includes audio circuitry connected to said microprocessor for at least one sound device.

15. A virtual business card sharing system as claimed in claim 11, wherein at least one of said devices further includes a plug-in memory interface for accepting an additional memory module.

16. An electronic device for storing and sharing contact information electronically, said device comprising:
a housing having walls that determine the shape and size of said device wherein said walls have an outside edge and an opposite inside edge;
a microprocessor contained within said inside edge of said walls of said housing for controlling the operation of said device;
a memory module contained within said inside edge of said walls for storing contact information;
an input/output processor contained with said inside edge of said walls;
an address bus connecting to each of said microprocessor, said memory module, and said input/output processor, said address bus is used for transferring information and instructions between said microprocessor, said memory module, and said input/output processor;
a data bus connecting to each of said microprocessor, said memory module, and said input/output processor, said address bus is used for transferring information and instructions between said microprocessor, said memory module, and said input/output processor;
a wireless radio module connected to said microprocessor for wireless communication capability;
a battery contained within said inside walls of said housing for powering said device;
at least one interface control connected to said input/output processor and located on said outside wall of said housing for allowing a user to interface with said device; and
control software stored on said memory module and executed by said microprocessor for controlling the functionality of said device.

17. A device as claimed in claim 16, wherein said device further includes a power management circuit connected to said battery and said microprocessor for managing all the power functions for said device.

18. A device as claimed in claim 16, wherein said device further includes a display screen on said outside edge of said housing and connected to said microprocessor for displaying device information.

19. A device as claimed in claim 16, wherein said wireless radio module is one of the Bluetooth, the Wibree, or the WUSB wireless radio protocols.

20. A device as claimed in claim 16, wherein said device further includes a hard wire communication port connected to said input/output processor and accessible from said outside edge of said housing for connecting to a multitude of compatible devices including computers, printers, and personal digital assistants.

21. A device as claimed in claim 16, wherein said device further includes audio circuitry connected to said microprocessor for the operation of at least one sound device.

22. A device as claimed in claim 16, wherein said device further includes a plug in memory interface for accepting at least one additional memory module for storing and transferring data.

23. A device as claimed in claim 16, wherein said device is integrated into a non-electronic object.

24. A device as claimed in claim 23, wherein said non-electronic object is one of a business card holder, a purse, a wallet, or a travel document holder.

25. A method for exchanging business or personal contact information suitable for storage in a contact information database between electronic devices equipped with a wireless radio module and/or a hard wire communication port, a memory module, and operating virtual business card software, said method comprising the steps of:
storing business or personal contact information on an electronic device;
activating the electronic device;
establishing a communication line with another electronic device;
sending said business or personal contact information via said communication line;
receiving said business or personal contact information via said communication line; and
transferring said business or personal contact information into the contact information database.

26. The method as claimed in claim 25, wherein the step of establishing a communication line with another electronic device further includes the step of determining whether other electronic devices operating virtual business card software are within range and available for communication.

27. The method as claimed in claim 25, wherein the step of sending said business or personal contact information via said communication line further includes the step of gaining approval for the sending of said information.

28. The method as claimed in claim 25, wherein said communication line is one of a wireless-type communication or a hardwire-type communication.

29. The method as claimed in claim 25, further including the step of establishing a communication line with a printer and printing stored contact information.

30. A method for exchanging business or personal contact information suitable for storage in a contact information database via a provided 2D bar code that is encoded with the contact information and an electronic device equipped with a camera and virtual business card software, said method including the steps of:
reading the bar code with the camera;
decoding the bar code back into the contact information data with the virtual business card software; and
storing the contact information data into the contact information database.

31. An electronic device for reading contact information encoded into a 2D bar code, said electronic device comprising:
a camera for reading the bar code;
a memory module for storing the bar code data;
software stored on said memory module for decoding the bar code; and
a microprocessor for running said software and said device.
